(19) United States
(12) Patent Application Publication
(10) Pub. No.: US 2015/0026232 A1
(43) Pub. Date: Jan. 22, 2015

(54) MEDICATIONS DIRECTING SYSTEM AND METHOD WITH CLOUD SERVER

(71) Applicant: HON HAI PRECISION INDUSTRY CO., LTD., New Taipei (TW)

(72) Inventors: JENG-CHE CHEN, New Taipei (TW); KUO-MING LAI, New Taipei (TW); PEI-YI CHAN, New Taipei (TW); PAO-HENG SHEN, New Taipei (TW); SZU-HAI HUANG, New Taipei (TW); TUI-CHIEN WU, New Taipei (TW); CHAO-WEN SHIH, New Taipei (TW); KING-LUNG HUANG, New Taipei (TW); LAP-SHUN HUI, New Taipei (TW)

(73) Assignee: HON HAI PRECISION INDUSTRY CO., LTD., New Taipei (TW)

(21) Appl. No.: 14/260,857

(22) Filed: Apr. 24, 2014

(30) Foreign Application Priority Data
Jul. 18, 2013 (TW) 102125787

(51) Int. Cl. H04L 29/08

(52) U.S. Cl. CPC H04L 67/125
USPC 709/202

(57) ABSTRACT

A monitoring system includes a cloud server, a first terminal, a second terminal, and a third terminal. The first, second and third terminal are connected to the cloud server. The cloud server includes an updating module and a storing module. The first terminal includes an obtaining module. The second terminal includes an analyzing module. The third terminal includes a downloading module. The obtaining module is used obtain a Body Mass Index to the cloud server, and the analyzing module is used to receive an updated dosage of reagents according to the Body Mass Index to the cloud server. The updating module is used to update an original dosage of reagents in the storing module according the updated dosage of reagents, and the downloading module is used to download the updated dosage of reagents, for allowing the third terminal to dispense pills. The disclosure further provides a monitoring method.

### FIELD

Embodiments of the present disclosure relate to directing systems and directing methods, and particularly to a medications directing system and a medication directing method with a cloud server.

### BACKGROUND

In view of the growth in treatable medical illnesses and conditions, numerous individuals are required to take one or more pills on a regular basis such as daily or once every four to six hours. To this end, there are a variety of pill dispensers, which enable multiple dosages of the pills to be placed into the dispenser, such that each dose is individually dispensed. A mechanical arm manipulates the dispenser each time a dosage consisting of one or more pills is required according to a predetermined dosage of reagents, for example, two capsules and three tablets. A BMI (body mass index) of a patient, for example, blood pressure, and heartbeat, may be changed, and the predetermined dosage of reagents maybe changed according to a suggestion of a doctor. However, it is inconvenient for the patient to obtain the predetermined dosage of reagents from the doctor every time.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like-reference numerals designate corresponding parts throughout the several views.

FIG. 1 is a schematic diagram of an embodiment of a medications directing system.

FIG. 2 is a block diagram of one embodiment of function modules of the medications directing system of FIG. 1.

FIGS. 3-4 are a flowchart of one embodiment of a medications directing method using the medications directing system of FIG. 2.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module,” as used hereinafter, refers to logic embodied in hardware or firmware, or to a collection of software instructions, written in a programming language, such as, for example, Java, C, or Assembly. One or more software instructions in the modules can be embedded in firmware. Modules can comprise connected logic units, such as gates and flip-flops, and programmable units, such as programmable gate arrays or processors. The modules described herein can be implemented as either software and/or hardware modules and can be stored in any type of computer-readable medium or computer storage device.

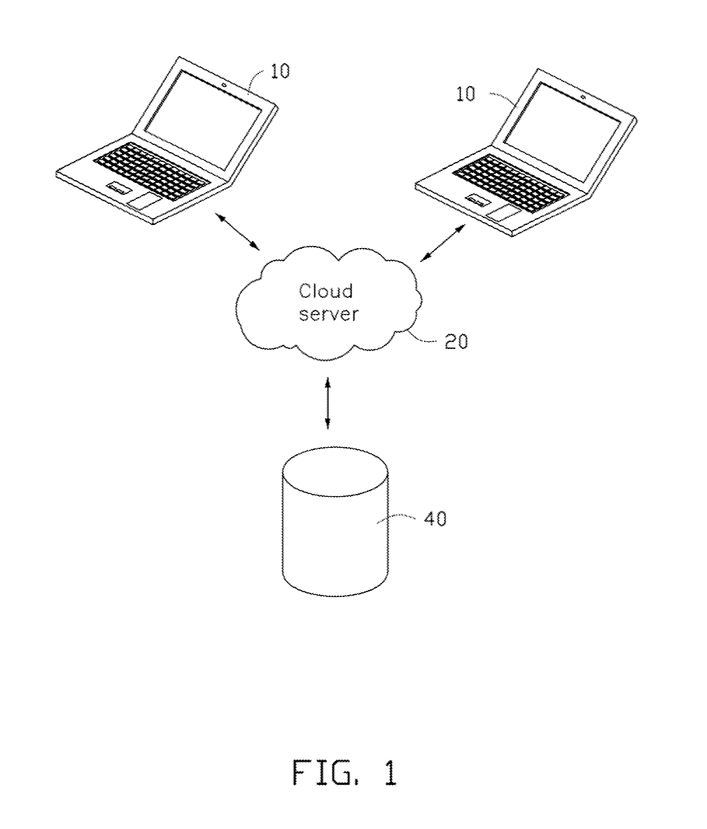

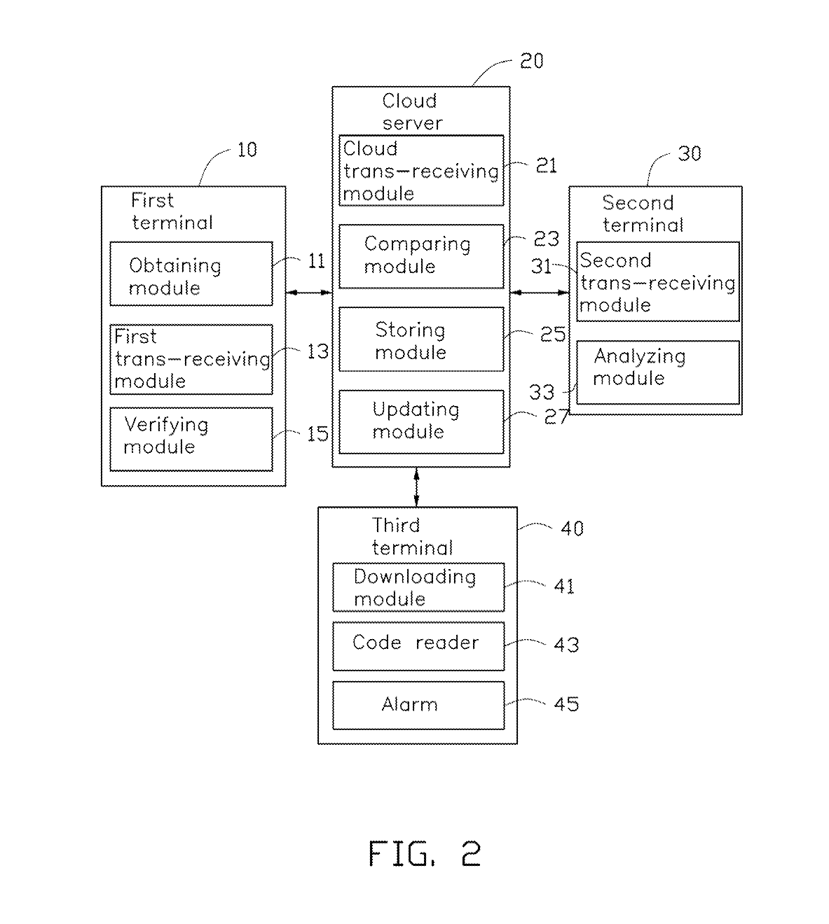

FIGS. 1-2 show one embodiment of a medications directing system. The medications directing system comprises a first terminal 10, a cloud server 20, a second terminal 30, and a third terminal 40. In one embodiment, each of the first terminal 10 and the second terminal 30 maybe a computer, a phone, or an IPAD, and the third terminal 40 is a pill dispenser, which can automatically dispense pills.

The first terminal 10 is connected to the cloud server 20 and comprises an obtaining module 11, a first trans-receiving module 13, and a verifying module 15. The verifying module 15 is used to obtain a reply verification code. The obtaining module 11 is used to obtain a BMI (body mass index) by a patient, for example, blood pressure, and heartbeat. The first trans-receiving module 13 is used to send the BMI and the reply verification code to the cloud server 20 and further used to receive an information from the cloud server 20.

The cloud server 20 comprises a cloud trans-receiving module 21, a comparing module 23, a storing module 25, and an updating module 27. The cloud trans-receiving module 21 is used to receive the BMI and the reply verification code from the first trans-receiving module 13 to send to the second terminal 30. The cloud trans-receiving module 21 is further used to send the information of the cloud server 20 to the first trans-receiving module 13 and is further used to send a request verification code to the first trans-receiving module 13. In one embodiment, the request verification code is consistent with the reply verification code. The comparing module 23 is used to compare whether the request verification code is consistent with the reply verification code. The storing module 25 is used to store consumer medicine information, for example, a patient information (age, sex, height) and a dosage of reagents corresponding to the patient information. The updating module 27 is used to update the dosage of reagents when request verification code is consistent with the reply verification code.

The second terminal 30 is connected to the cloud server 20 and comprises a second trans-receiving module 31 and an analyzing module 33. The second trans-receiving module 31 is used to receive the BMI from the cloud trans-receiving module 21. The analyzing module 33 can determine whether to receive an updated dosage of reagents. For example, when the BMI received by the second trans-receiving module 31 shows that the dosage of reagents needs not be updated, the analyzing module 33 does not receive the updated dosage of reagents. When the BMI received by the second trans-receiving module 31 shows that the dosage of reagents need to be updated, the analyzing module 33 receives the updated dosage of reagents by an user, such as a doctor. The second trans-receiving module 31 is further used to send the updated dosage of reagents to the cloud trans-receiving module 21.

When the cloud trans-receiving module 21 receives the updated dosage of reagents, the cloud trans-receiving module 21 sends the request verification code to the first trans-receiving module 13.

The third terminal 40 is connected to the cloud server 20 and comprises a downloading module 41, a code reader 43, and an alarm 45. The downloading module 41 is used to download the updated dosage of reagents from the storing module 25. The code reader 43 is used to search the corresponding pills according to the updated dosage of reagents. The alarm 45 is used to alarm when the code reader 43 cannot search the corresponding pills.

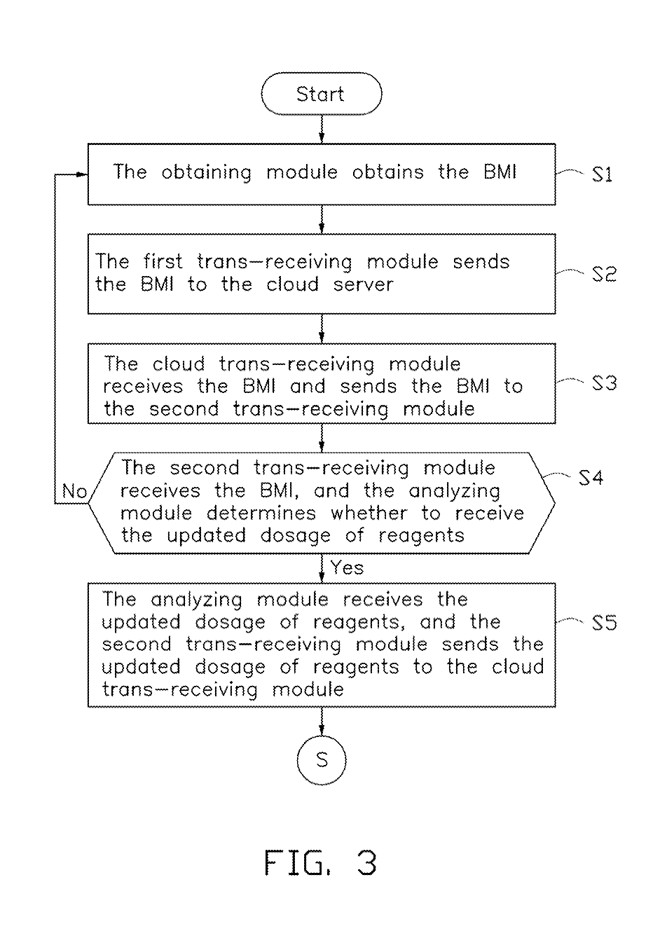

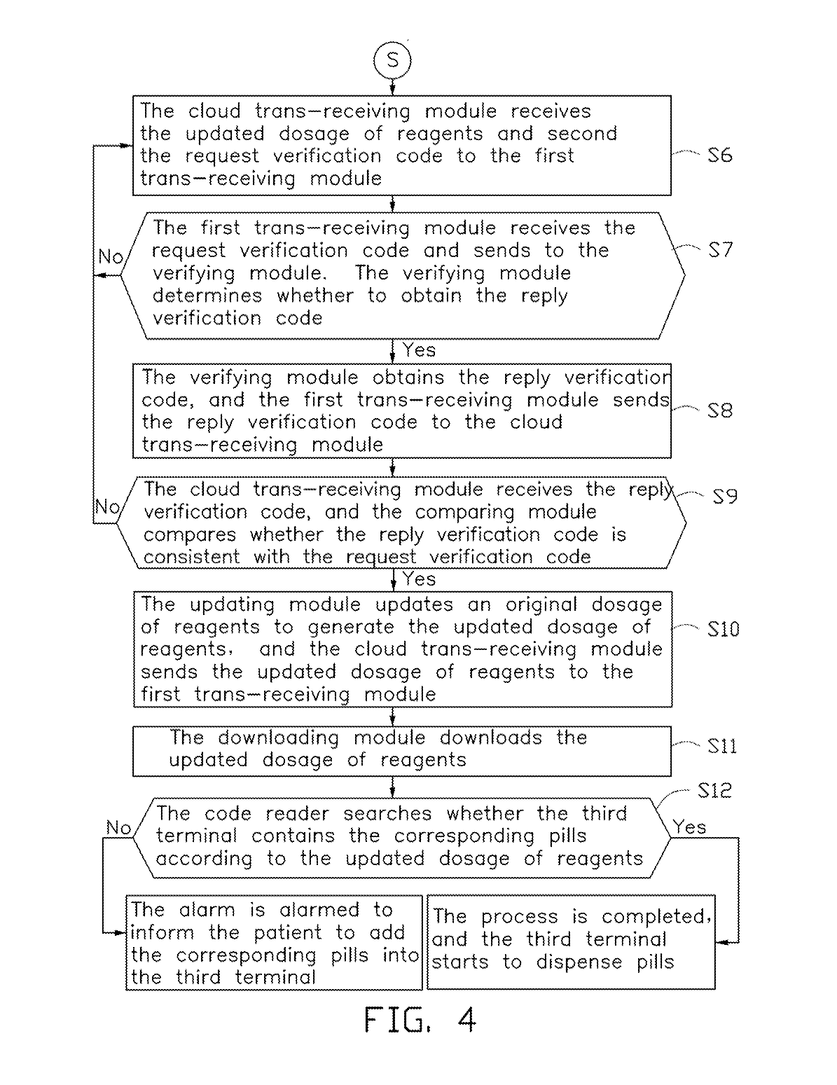

FIGS. 3-4 are a flowchart of one embodiment of a medications directing method using the medications directing system in FIGS. 1-2. Depending on the embodiment, additional steps may be added, others removed, and the ordering of the steps may be changed.

In step S1, the obtaining module 11 obtains the BMI of a patient, for example, blood pressure, and heartbeat.

In step S2, the first trans-receiving module 13 sends the BMI of the obtaining module 11 to the cloud server 20.

In step S3, the cloud trans-receiving module 21 receives the BMI and sends the BMI to the second trans-receiving module 31.

In step S4, the second trans-receiving module 31 receives the BMI, and the analyzing module 33 determines whether to receive the updated dosage of reagents, If not, step S1 is repeated. If yes, the process goes on to step S5.

In step S5, the analyzing module 33 receives the updated dosage of reagents according to the BMI by the doctor, and the second trans-receiving module 33 sends the updated dosage of reagents to the cloud trans-receiving module 21.

In step S6, the cloud trans-receiving module 21 receives the updated dosage of reagents and second the request verification code to the first trans-receiving module 13.

In step S7, the first trans-receiving module 13 receives the request verification code and sends to the verifying module 15. The verifying module 15 determines whether to obtain the reply verification code, if not, step S6 is repeated. If yes, the process goes on to step S8.

In step S8, the verifying module 15 obtains the reply verification code, and the first trans-receiving module 13 sends the reply verification code to the cloud trans-receiving module 21.

In step S9, the cloud trans-receiving module 21 receives the reply verification code, and the comparing module 23 compares whether the reply verification code is consistent with the request verification code, if not, step S6 is repeated. If yes, the process goes on to step S10.

In step S10, the updating module 27 updates an original dosage of reagents in the storing module 25 to generate the updated dosage of reagents in the storing module 25. Simultaneously, the cloud trans-receiving module 21 sends the updated dosage of reagents to the first trans-receiving module 13.

In step S11, the downloading module 41 downloads the updated dosage of reagents from the storing module 25.

In step S12, the code reader 43 searches whether the third terminal contains the corresponding pills according to the updated dosage of reagents. If yes, the process is completed, and the third terminal 40 starts to dispense pills. If no, the alarm 45 is alarmed to inform the patient to add the corresponding pills into the third terminal.

Although certain inventive embodiments of the present disclosure have been specifically described, the present disclosure is not to be construed as being limited thereto. Various changes or modifications may be made to the present disclosure without departing from the scope of the present disclosure and the following claims.

What is claimed is:

1. A medication directing system comprising:
a cloud server comprising an updating module and a storing module;
a first terminal connected to the cloud server and comprising an obtaining module;
a second terminal connected to the cloud server and comprising an analyzing module; and
a third terminal connected to the cloud server and comprising a downloading module;
wherein the obtaining module is configured to obtain a Body Mass Index to send to the cloud server; the analyzing module is configured to receive an updated dosage of reagents according to the Body Mass Index to send to the cloud server; the updating module is configured to update an original dosage of reagents in the storing module according the updated dosage of reagents; and the downloading module is configured to download the updated dosage of reagents from the storing module, for allowing the third terminal to dispense pills according to the updated dosage of reagents.

2. The medication directing system of claim 1, wherein the cloud server further comprise a cloud transreceiving module configured for receiving the Body Mass Index, and the first terminal further comprises a first trans-receiving module configured to send the Body Mass Index to the cloud trans-receiving module.

3. The medication directing system of claim 2, wherein the second terminal further comprises a second trans-receiving module, the second trans-receiving module is configured to receive the Body Mass Index from the cloud trans-receiving module, and the Body Mass Index used by the analyzing module is from the second trans-receiving module.

4. The medication directing system of claim 2, wherein the cloud trans-receiving module is further configured to send a request verification code to the first trans-receiving module, and the first terminal further comprises a verifying module configured to obtain a reply verification code according to the request verification code.

5. The medication directing system of claim 3, wherein the cloud server further comprises a comparing module, the comparing module is configured to compare whether the reply verification code is consistent with the request verification code, and the updating module is configured to update the original dosage of reagents when the reply verification code is consistent with the request verification code.

6. The medication directing system of claim 1, wherein the third terminal further comprises a code reader and an alarm, the code reader is configured to search whether the third terminal contains corresponding pills according to the updated dosage of reagents; when the third terminal contains corresponding pills, the third terminal is configured to start to dispense pills, and when the third terminal contains no corresponding pills, the alarm is configured to be alarmed to inform adding the corresponding pills into the third terminal.

7. The medication directing system of claim 1, wherein the third terminal is a pill dispenser.

8. A medication directing method comprising:
connecting a first terminal, a second terminal, and a third terminal to a cloud server;
obtaining a Body Mass Index by a obtaining module in the first terminal;
receiving an updated dosage of reagents according to the Body Mass Index by an analyzing module in the second terminal;
update an original dosage of reagents in the storing module according the updated dosage of reagents by an updating module in the cloud server;
storing the updated dosage of reagents in a storing module in the cloud server;
downloading the updated dosage of reagents from the storing module by a the downloading module in the third terminal, for allowing the third terminal to dispense pills according to the updated dosage of reagents.

9. The medication directing method of claim 8, further comprising a step of sending the Body Mass Index to a could trans-receiving module in the could server by a first trans-receiving module in the first terminal after the step of obtaining the Body Mass Index by the obtaining module in the first terminal to the cloud server.

10. The medication directing method of claim 9, further comprising a step of sending a request verification code to the first trans-receiving module by the cloud trans-receiving module before the step of receiving the updated dosage of reagents according to the Body Mass Index by the analyzing module in the second terminal.

11. The medication directing method of claim 10, further comprising a step of receiving the request verification code and sending the request verification code to a verifying module of the first terminal by the first trans-receiving module after the step of sending the request verification code to the first trans-receiving module.

12. The medication directing method of claim 11, further comprising a step of obtaining a reply verification code by the verifying module to send to the first trans-receiving module, for allowing the first trans-receiving module to send the reply verification code to the cloud trans-receiving module, after the step of receiving the request verification code and sending the request verification code to the verifying module.

13. The medication directing method of claim 8, further comprising a step of comparing whether the reply verification code is consistent with the request verification code by a comparing module in the cloud server before the step of updating the original dosage of reagents in the storing module according the updated dosage of reagents by the updating module in the cloud server.

14. The medication directing method of claim 8, further comprising a step of searching whether the third terminal contains corresponding pills according to the updated dosage of reagents, when the third terminal contains corresponding pills, the third terminal starts to dispense pills, and when the third terminal contains no corresponding pills, the alarm is alarmed to inform adding the corresponding pills into the third terminal after downloading the updated dosage of reagents from the storing module by the downloading module in the third terminal.

15. The medication directing method of claim 8, wherein the third terminal is a pill dispenser.
